(19) United States
(12) Patent Application Publication
(10) Pub. No.: US 2018/0314495 A1
(43) Pub. Date: Nov. 1, 2018

(54) METHOD AND APPARATUS FOR MANAGING SOFTWARE

(71) Applicant: Electronics and Telecommunications Research Institute, Daejeon (KR)

(72) Inventors: Hyun Jeong Lee, Daejeon (KR); Sangkeun Yoo, Sejong-si (KR); Yong-Woon Kim, Asan-si (KR)

(73) Assignee: Electronics and Telecommunications Research Institute, Daejeon (KR)

(21) Appl. No.: 15/962,113

(22) Filed: Apr. 25, 2018

(30) Foreign Application Priority Data
Apr. 28, 2017 (KR) 10-2017-0055619
Jul. 11, 2017 (KR) 10-2017-0087589
Jul. 12, 2017 (KR) 10-2017-0088186
Oct. 16, 2017 (KR) 10-2017-0133848
Oct. 17, 2017 (KR) 10-2017-0134348
Mar. 19, 2018 (KR) 10-2018-0031648

(51) Int. Cl. G06F 8/10; G06F 8/20; G06F 8/35

(52) U.S. Cl. CPC G06F 8/10; G06F 8/35; G06F 8/20

(57) ABSTRACT

A method and apparatus for managing software are provided. The method includes decomposing a requirement input by a user into one or more capabilities using a capability class structure (CCS) corresponding to the requirement, creating a required capability profile corresponding to the requirement using a capability template corresponding to the capabilities, matching the required capability profile and an existing capability profile in a software unit catalogue, and assessing the existing capability profile matched with the required capability profile.

### CROSS-REFERENCE TO RELATED APPLICATIONS

This application claims the priority benefit of Korean Patent Application No. 10-2017-0055619 filed on Apr. 28, 2017, Korean Patent Application No. 10-2017-0087589 filed on Jul. 11, 2017, Korean Patent Application No. 10-2017-0088186 filed on Jul. 12, 2017, Korean Patent Application No. 10-2017-0133848 filed on Oct. 16, 2017, Korean Patent Application No. 10-2017-0134348 filed on Oct. 17, 2017, and Korean Patent Application No. 10-2018-0031648 filed on Mar. 19, 2018, in the Korean Intellectual Property Office, the disclosures of which are incorporated herein by reference for all purposes.

### BACKGROUND

### 1. Field of the Invention

The following description relates to a method and apparatus for managing software, and more particularly, to a method and apparatus for creating a capability profile for matching and assessing software that satisfies user's requirements based on an interoperability, and for performing matching and assessment using the capability profile.

### 2. Description of the Related Art

In response to a weakened labor market and a revolution in smart industries, smart factories are spreading. A smart factory refers to a customized factory that integrates the entire manufacturing process with information and communication technology (ICT) to optimize a production system by, for example, enhancing productivity and energy efficiency or reducing a product defect rate.

Also, the smart factory may be implemented by integrating an existing manufacturing process with ICT such as Internet of Things (IoT), big data, or cloud computing. In the smart factory, a manufacturing period may be shortened due to a simulation in a virtual space before manufacturing of a product in a planning and design stage, and a product customized for a consumer may be developed.

Since different types of objects are interconnected and information is exchanged, a user needs software for smart factories to structuralize and manage data at a manufacturing site.

Thus, there is a need for a technology to provide a consumer with software for different types of smart factories to build and operate a smart factory received from a provider. In other words, there is a desire for a development of a technology of comparing a software capability requirement of a consumer to a software capability description of a provider and of assessing a software interoperation level to provide the consumer with software for an optimal smart factory.

### SUMMARY

Example embodiments provide a method and apparatus for assessing a software interoperation level between a capability requirement of a consumer and a capability description of a provider providing software for a smart factory.

Software for an optimal smart factory corresponding to a capability requirement may be recommended to a consumer.

Redundant software for a similar smart factory may be prevented from being developed by a provider, and resources of software for a smart factory may be efficiently managed.

According to an aspect, there is provided a method of managing software, the method including decomposing a requirement input by a user into one or more capabilities using a capability class structure (CCS) corresponding to the requirement, creating a required capability profile corresponding to the requirement using a capability template corresponding to the capabilities, matching the required capability profile and an existing capability profile in a software unit catalogue, and assessing the existing capability profile matched with the required capability profile.

The method may further include determining whether a CCS for a manufacturing application to be developed exists in a CCS repository, and creating a CCS for a decomposition of the requirement into one or more capabilities and registering the created CCS to the CCS repository when the CCS does not exist in the CCS repository.

The CCS may represent a structure of capability classes for a decomposition of required capabilities.

The decomposing of the requirement may include decomposing the requirement into one or more capabilities again when an existing capability profile matched with the required capability profile does not exist.

When the capability template corresponding to the capabilities does not exist, a capability template corresponding to the capabilities may be created and registered to a capability template repository.

The matching of the required capability profile and the existing capability profile may include comparing capability elements specified in the required capability profile to capability elements of the existing capability profile, and matching the required capability profile and the existing capability profile.

The matching of the required capability profile and the existing capability profile may include matching the required capability profile and the existing capability profile based on whether a mandatory capability element and an optional capability element of the required capability profile are the same as a mandatory capability element and an optional capability element of the existing capability profile, respectively.

The assessing of the existing capability profile may include assessing an interoperability between existing capability profiles matched with the required capability profile.

The assessing of the existing capability profile may include assessing the existing capability profile based on an assessment indicator that includes at least one of a communication protocol, data sharing, data exchange, and service calling.

The method may further include outputting a result of the assessing as an assessment report.

The assessment report may include an identification (ID) of the required capability profile, an ID of the assessed existing capability profile, and an assessment result for each assessment indicator.

The capability template, the required capability profile and the existing capability profile may be based on common terms defined in a software capability description dictionary.

According to another aspect, there is provided a method of managing software, the method including decomposing requirements for a new software unit into a plurality of primitive requirements by reference to an activity tree in domain activities, selecting a capability template corresponding to a capability class that satisfies the decomposed requirements, creating a capability profile by filling the capability template with concrete values of the new software unit, and registering the capability profile to a software unit catalogue.

The selecting of the capability template may include determining whether the capability template corresponding to the capability class exists in a capability template repository by reference to a software capability description dictionary, creating a new capability template with the same formal structure as a formal structure of the capability template when the capability template does not exist in the capability template repository, and registering the created new capability template to the capability template repository. The software capability description dictionary may be updated to reflect semantics of the created new capability template.

A capability element in the software capability description dictionary may include a capability element name, a capability element type, a name of a reference manufacturing domain model (MDM), and a list of functions with function names and function types.

The creating of the capability profile may include creating the capability profile by coding capability elements to recognize semantics.

The method may further include selecting a manufacturing domain for the new software unit.

A capability class that satisfies the decomposed requirements may be created or may be reused when an existing capability class satisfies the decomposed requirements.

According to another aspect, there is provided an apparatus for managing software, the apparatus including a processor, and a memory that includes at least one instruction that is executable by the processor, wherein when the at least one instruction is executed by the processor, the processor is configured to decompose a requirement input by a user into one or more capabilities using a CCS corresponding to the requirements, configured to create a required capability profile corresponding to the requirement using a capability template corresponding to the decomposed capabilities, configured to match the required capability profile and an existing capability profile in a software unit catalogue, and configured to assess the existing capability profile matched with the required capability profile.

According to another aspect, there is provided an apparatus for managing software, the apparatus including a processor, and a memory that includes at least one instruction that is executable by the processor, wherein when the at least one instruction is executed by the processor, the processor is configured to decompose requirements for a new software unit into a plurality of primitive requirements by reference to an activity tree in domain activities, configured to select a capability template corresponding to a capability class that satisfies the decomposed requirements, configured to create a capability profile by filling the capability template with concrete values of the new software unit, and configured to register the capability profile to a software unit catalogue.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a relationship among a manufacturing domain model (MDM), manufacturing domain data (MDD), a capability template and a capability profile according to an example embodiment;

FIG. 2 is a diagram illustrating a capability profiling using MDD according to an example embodiment;

FIG. 3 is a diagram illustrating an inconsistent profiling for the same manufacturing software unit (MSU) according to an example embodiment;

FIG. 4 is a diagram illustrating a concept of a software capability description dictionary according to an example embodiment;

FIG. 5 is a diagram illustrating a conceptual structure of a common part of an MSU to represent a software capability description dictionary according to an example embodiment;

FIG. 6 is a diagram illustrating a relationship among a software unit catalogue and other components according to an example embodiment;

FIG. 7 is a diagram illustrating an overall procedure of a software unit cataloging according to an example embodiment;

FIG. 8 is a diagram illustrating a software unit catalogue according to an example embodiment;

FIG. 9 is a diagram illustrating a capability profiling and registration procedure according to an example embodiment;

FIG. 10 is a diagram illustrating an update of a software capability description dictionary according to an example embodiment;

FIG. 11 is a diagram illustrating a conceptual structure of a capability element template according to an example embodiment;

FIG. 12 is a diagram illustrating an overall procedure of a capability unit assessment according to an example embodiment;

FIG. 13 is a diagram illustrating a conceptual structure of a specific part in a capability template according to an example embodiment;

FIG. 14 is a flowchart illustrating a capability unit matching procedure according to an example embodiment;

FIG. 15 is a flowchart illustrating an assessment procedure according to an example embodiment;

FIG. 16 is a diagram illustrating a conceptual structure of an assessment report according to an example embodiment; and

FIG. 17 is a diagram illustrating an apparatus for managing software according to an example embodiment.

### DETAILED DESCRIPTION

The following structural or functional descriptions of example embodiments described herein are merely intended for the purpose of describing the example embodiments and may be implemented in various forms. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings. The scope of the right, however, should not be construed as limited to the example embodiments set forth herein. Like reference numerals in the drawings refer to like elements throughout the present disclosure.

The present disclosure relates to a set of template definitions to describe a capability of a software unit of an automation solution that may be mapped to functional requirements of a target manufacturing application. Also, in the present disclosure, a method of developing and managing a software unit catalogue in terms of capability properties may be specified, and mapping rules from capability profiles to a software unit catalogue may be defined.

According to an example embodiment, a capability may be a set of functions and services with a set of criteria to evaluate a performance of a capability provider of software. Also, the capability may be defined as a quality of being able to perform a given activity.

A capability profile may be an example of a capability template filled with concrete values corresponding to a target manufacturing software unit (MSU).

A capability profiling may be defined as a selection of a set of provided services defined by a specific interface within a software interoperability framework.

A capability class may be an element within a capability profiling method that represents software unit functionality and behaviour in association with a software unit role in a manufacturing activity.

A capability class structure (CCS) may be a hierarchy of capability classes. The CCS may be intended for modeling of capability aggregation hierarchies in a target domain.

A template may be a schema for a manufacturing software capability profile.

A capability template may be a schema representing a capability class.

A capability template repository may be a database configured to store a capability template.

An MSU may be a class of a software resource that includes one or more manufacturing software components and that performs a definite function or role within a manufacturing activity while supporting a common information exchange mechanism with other units. The MSU may be modeled using a unified modeling language (UML) as a software object.

Manufacturing domain data (MDD) may be information about manufacturing resources, manufacturing activities, or items exchanged among manufacturing resources within a specific manufacturing domain.

A capability element may be a specific type of MDD used to indicate that a specific capability is supported by entities or an MSU to which an element belongs.

A manufacturing domain model (MDM) may be a specific view of a manufacturing domain, may include MDD and a relationship among the MDD and may correspond to domain's application.

A software capability description dictionary may be a dictionary for capability elements to describe a capability of software.

A software unit catalogue may be a collection of capability profiles using the same capability template representing one or more MSUs for the same manufacturing activity in an activity tree.

A software unit cataloguing may be a procedure of forming a software catalogue(*unit catalogue.

An MSU provider may be an entity that provides an MSU registered to the software unit catalogue.

In the present disclosure, four templates (for example, a CCS template, a capability template, an MDM template, and an MDD template) may be used in an MSU capability profiling when multiple CCSs are present.

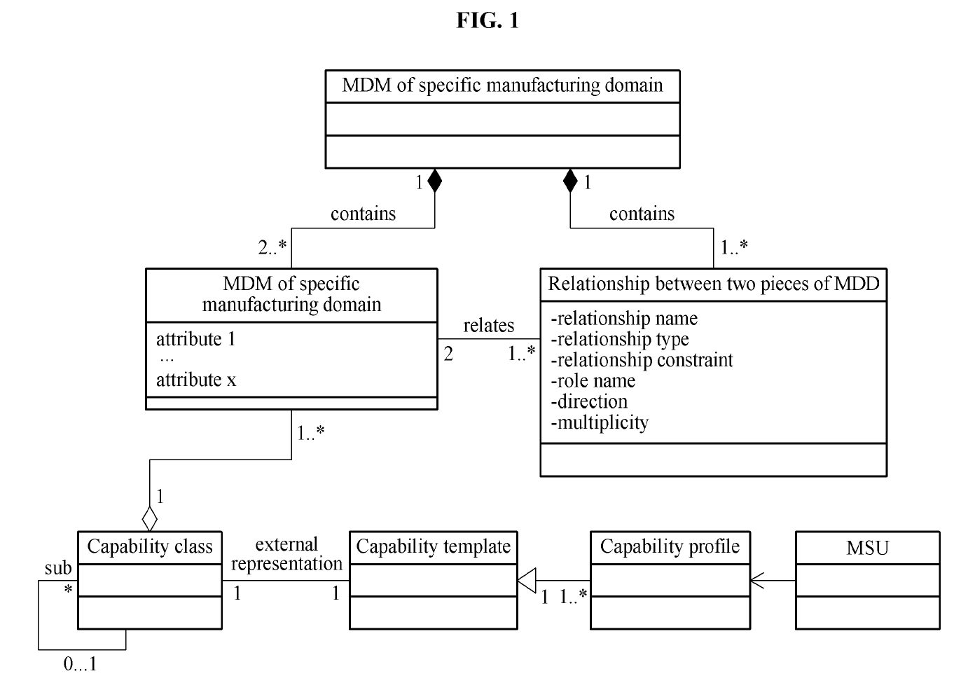

FIG. 1 illustrates a relationship among an MDM, MDD, a capability template and a capability profile according to an example embodiment.

The MDM may be a specific view of a specific manufacturing domain and may include MDD and a relationship with the MDD.

The MDD may represent the following items:

manufacturing resources (for example, an MSU, equipment, an automation device, personnel, materials, and work-in process inventory);

manufacturing processes (for example, operations and activities);

exchanged manufacturing information (for example, product data, a recipe, manufacturing data, and quality data); and

relationships among resources, processes and exchanged information (for example, a data flow, a network configuration and a work flow).

A capability class may need to be a capability that is externally represented as a capability template. A capability profile may be an instance of a capability template filled with concrete values corresponding to a target MSU. Thus, a capability of an MSU may be described by MDD in a capability template.

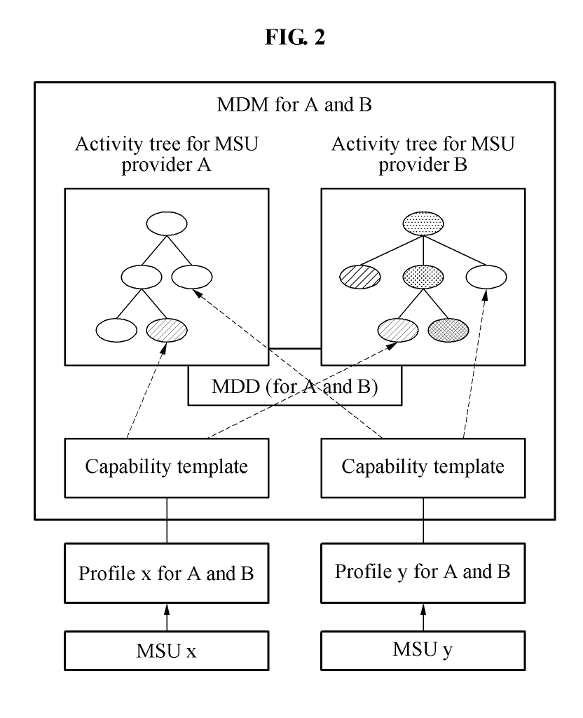

FIG. 2 is a diagram illustrating a capability profiling using MDD according to an example embodiment.

FIG. 2 illustrates an example of a capability profiling for an MSU using MDD. In FIG. 2, an MSU x of an MSU provider A and an MSU y of an MSU provider B may be profiled using the same capability template using MDD. Thus, a single profile may exist for each MSU, and a manufacturing software reusability and an interoperability of an application integrated through a selected MSU may be provided.

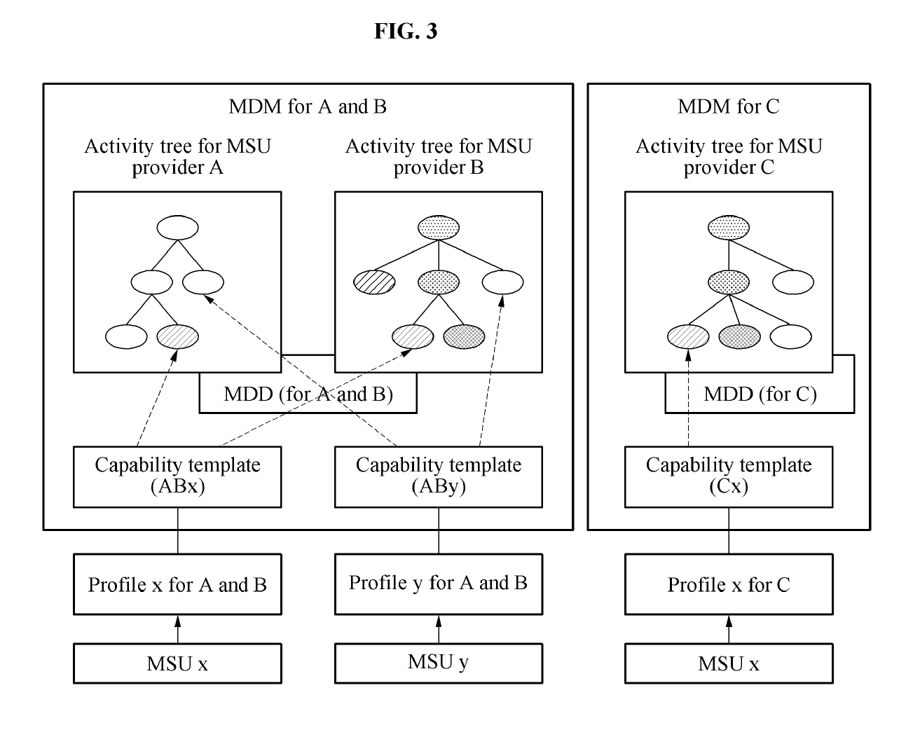

FIG. 3 is a diagram illustrating an inconsistent profiling for the same MSU according to an example embodiment.

Since a manufacturing software reusability and an interoperability of an application may be provided by even an MDD-based capability profiling, an inconsistent capability profiling for the same MSU may still exist.

FIG. 3 illustrates an example of an inconsistent capability profiling for the same MSU, for example, an MSU x, in which a capability template Cx provided by an MSU provider C resides in a different location from an MDM for an MSU provider A and an MSU provider B.

In FIG. 3, different capability templates, for example, capability templates ABx and Cx, may be used to profile the MSU x, and thus different profiles for the same MSU may be created.

The capability template ABx for the MSU x may provide the manufacturing software reusability and the interoperability of the application in the MDM for only the MSU provider A and MSU provider B as described above with reference to FIG. 1.

Considering a MSU provider C, different capability templates for the same MSU, that is, the MSU x may be present, which may break a rule of one profile for the same MSU.

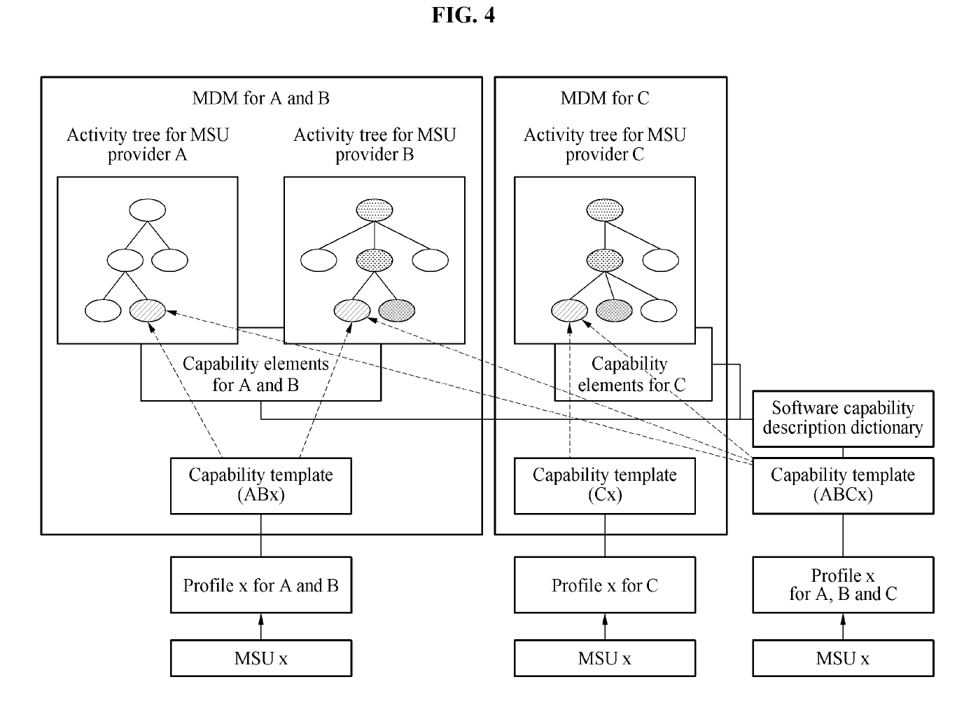

FIG. 4 is a diagram illustrating a concept of a software capability description dictionary according to an example embodiment.

Objectives of a software unit catalogue may be to (1) enhance a manufacturing software reusability and an interoperability of applications and to (2) provide a mechanism for creating one capability profile for the same MSU on the same manufacturing activity in an activity tree using the same capability template. For the above objectives, a software capability description dictionary for capability elements to describe a capability of software may be defined as shown in FIG. 4.

The software capability description dictionary may need to provide mutual understanding of semantics of capability templates that may be understood by referencing different sources of capability elements. For the mutual understanding of semantics of capability templates, a target capability element in which all terms required to understand the semantics of the capability templates are defined may be referenced.

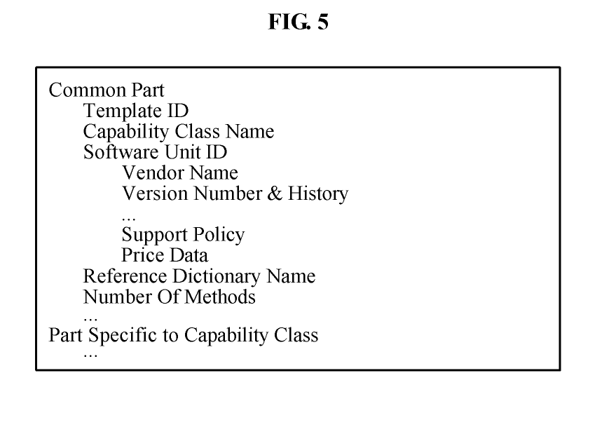

FIG. 5 is a diagram illustrating a common part of an MSU to represent a software capability description dictionary according to an example embodiment.

FIG. 5 illustrates a relationship between a software unit catalogue and a software capability description dictionary. The software unit catalogue may need to be coded based on a concept of the software capability description dictionary and may need to conform to constraints in a capability template. Software capability description dictionary information may be coded to a reference dictionary name of the common part as shown in FIG. 5.

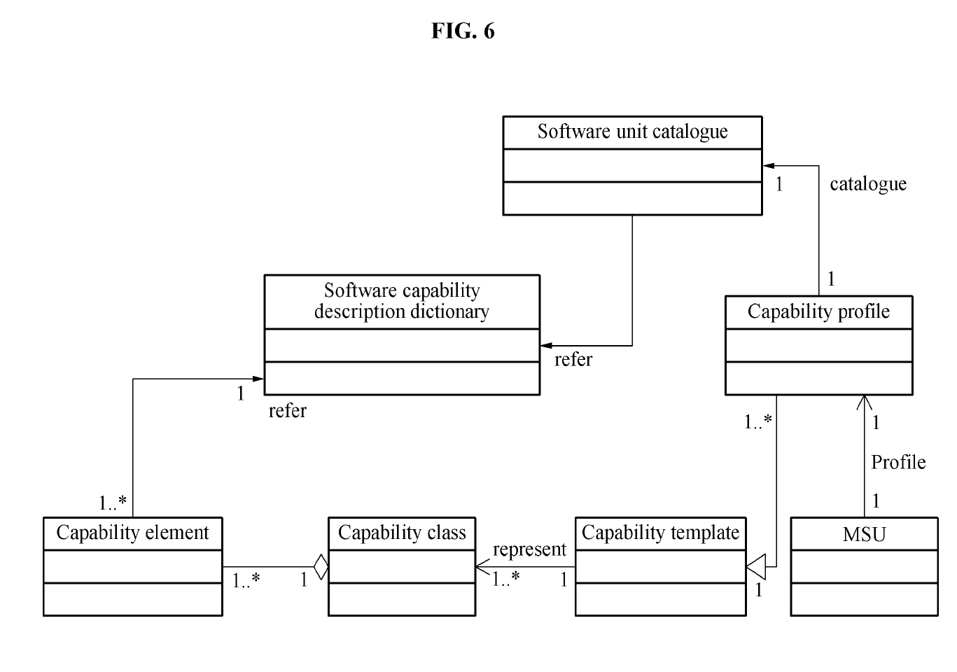

FIG. 6 is a diagram illustrating a relationship between a software unit catalogue and other components according to an example embodiment.

FIG. 6 illustrates a relationship among a software unit catalogue, a software capability description dictionary, a capability template, a capability profile, a capability class and a capability element. The capability element may include a preferred name, an identifier, one or more definitions, terms or abbreviations, sources of corresponding definitions and symbols (for example, graphical and language-independent symbols).

The software unit catalogue may need to reference the software capability description dictionary to interpret semantics of the capability template and the capability profile. Each MSU may have one capability profile, and each capability profile may belong to one capability template in the software unit catalogue.

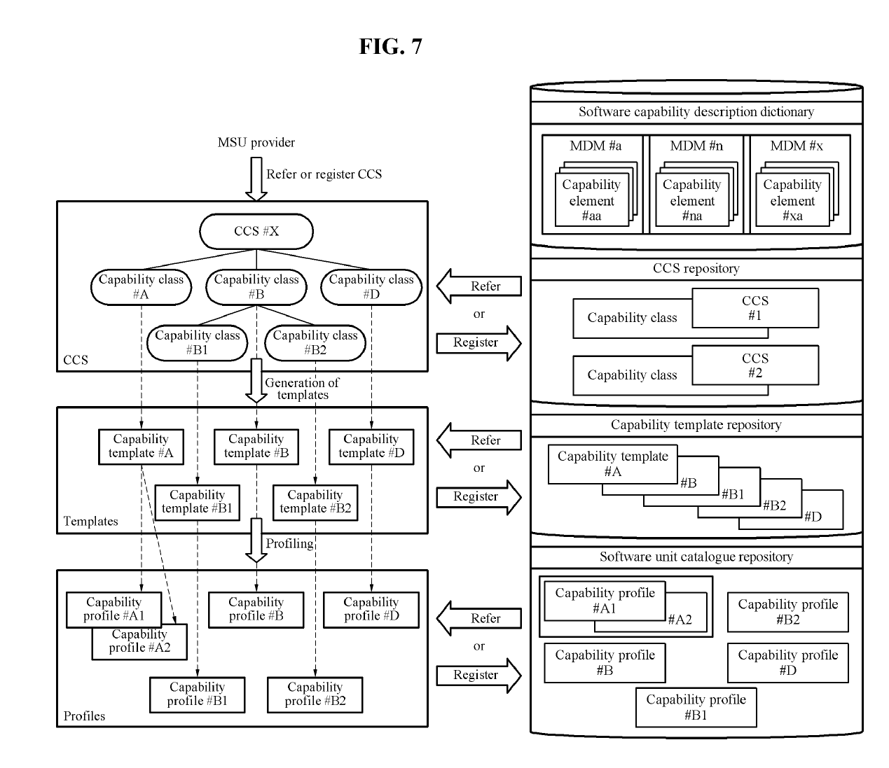

FIG. 7 is a diagram illustrating an overall procedure of a software unit cataloging according to an example embodiment.

A procedure of a software unit cataloging according to an example embodiment is described below.

A set of activities that may be performed by an MSU may be analyzed. The MSU may enable one or more activities.

A capability class corresponding to each activity may be identified, and a CCS to which the capability class belongs may be searched for. When an MSU provides capabilities for two or more activities, the activities may belong to the same CCS or a different CCS.

A capability template may be selected for each capability class identified with reference to the software capability description dictionary.

When a suitable CCS does not exist, an appropriate CCS may be constructed and registered to a CCS repository. Also, corresponding capability templates may be created and registered to a capability template repository. Thus, the software capability description dictionary may be updated.

An MSU capability profile may be created by filling the selected capability template or a new capability template created as described above with concrete values, and a corresponding capability template may be registered to the capability template repository.

An MSU provider may register a capability profile to a software unit catalogue. The software unit catalogue may be managed by an appropriate database system.

In FIG. 7, a left portion illustrates a sequence of the software unit cataloging, and a right portion illustrates a software capability description dictionary, and repositories configured to store CCSs, capability templates and software unit catalogues.

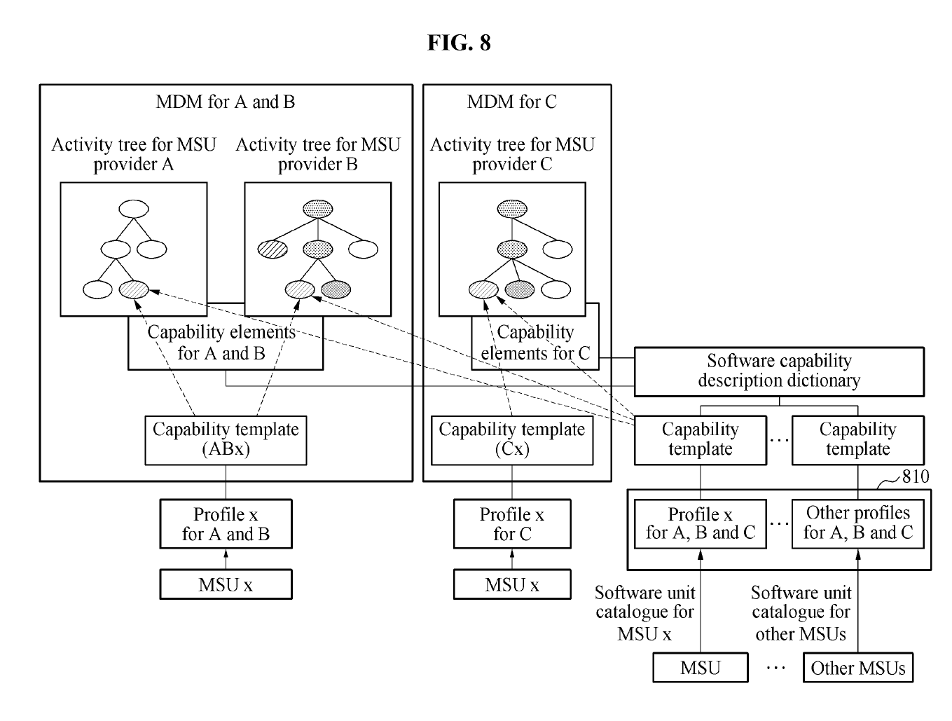

FIG. 8 is a diagram illustrating a software unit catalogue according to an example embodiment.

FIG. 8 illustrates a capability profiling using a software unit catalogue resulted from the software unit cataloging defined in FIG. 7. In FIG. 8, a box 810 represents a software unit catalogue.

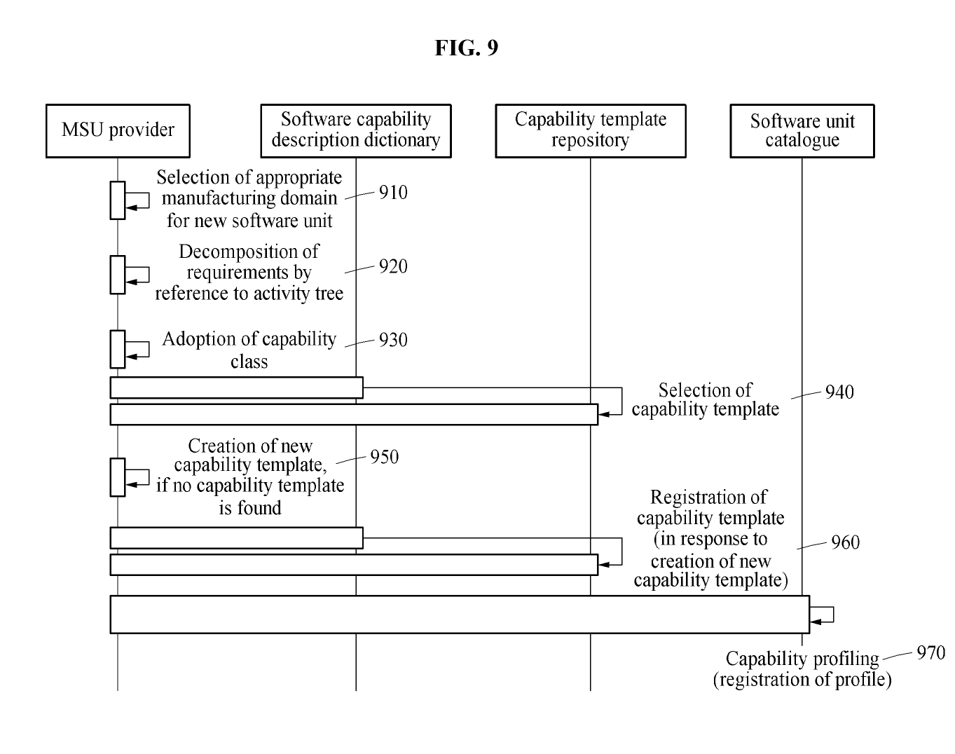

FIG. 9 is a diagram illustrating a capability profiling and registration procedure according to an example embodiment.

A capability profiling and registration procedure performed by an apparatus for managing software according to an example embodiment is described below.

In operation 910, an appropriate manufacturing domain for a new software unit may be selected.

In operation 920, a requirement for the new software unit may be decomposed into a plurality of primitive requirements by reference to an activity tree in a domain activity.

In operation 930, a capability class that satisfies requirements may be created or reused when an existing capability class satisfies the requirements. In operation 940, an appropriate capability template corresponding to the capability class may be selected. For a setup and/or a selection of a capability template, whether the capability template exists in a capability template repository may be retrieved with reference to a software capability description dictionary.

In operation 950, a new capability template may be created with the same formal structure as that of the capability template when a corresponding capability template is not found in the capability template repository.

In operation 960, the capability template may be registered to the capability template repository when a new capability template is created, and the software capability description dictionary may be updated to reflect semantics of the capability template.

In operation 970, a capability template may be filled with concrete values to create a capability profile. Also, capability elements may be coded into a capability profile to recognize semantics. The capability profile may be registered to the software unit catalogue.

An example of a capability profile coded without a software capability description dictionary and a capability profile coded with the software capability description dictionary may be shown below.

| Specific part of capability profile coded | Specific part of capability profile coded with |
|---|---|
| without MDD dictionary information | MDD dictionary information |
| <Common Part> | <Common Part> |
| ................ | ................ |
| </Common Part> | </Common Part> |
| <Specific Part> | <Specific Part> |
| ................ | ................ |

| | |
|---|---|
| <Set_operations_in_activity> | <Set_operations_in_activity> |

| | |
|---|---|
| <operation1> | <operation1> |

| | |
|---|---|
| ..................... | ..................... |

| | |
|---|---|
| </operation1> | </operation1> |
| <operation2 action=″Set″ name=″Select″ | <operation2 action=″0200-1#11- |

| | |
|---|---|
| status=″mandatory″> | 116650#1″ name=″0200-1#11-116651#1″ |
| | status=″0200-1#07-006650#1″> |

| | |
|---|---|
| <exchanged_information> | <exchanged_information> |

| | |
|---|---|
| <information_out_in_1> | <information_out_in_1> |

| | |
|---|---|
| <information_out name=″User″ | <information_out name=″0200- |

| value=″John″ /> | | 1#12-124020#1″ value=″0200-1#07- |
|---|---|---|
| | </information_out_in_1> | 004337#1″ /> |

</information_out_in_1>

<information_out_in_2>

| | |
|---|---|
| <information_out name=″Pid″ | <information_out_in_2> |

| | |
|---|---|
| value=″1″ /> | <information_out name=″0200- |

1#12-124057#1″ value=″1″ />

| | |
|---|---|
| </information_out_in_2> | </information_out_in_2> |
| <information_out_in_3> | <information_out_in_3> |

| | |
|---|---|
| <information_out | <information_out name=″0200- |

| name=″OpDes″ value=″open″ /> | | 1#12-124169#1″ value=″0200-1#07- |
|---|---|---|
| | </information_out_in_3> | 004430#1” /> |

</information_out_in_3>

<information_out_in_4>

| | |
|---|---|
| <information_in name=″Lock″ | <information_out_in_4> |

| | |
|---|---|
| value=″true″ /> | <information_in name=”0200- |

| | |
|---|---|
| </information_out_in_4> | 1#12-124095#1″ value=″0200-1#07- |

004449#1″ />

| | |
|---|---|
| <information_out_in_5> | </information_out_in_4> |

<information_in

| | |
|---|---|
| name=″CheckChannelResult″ value=″true″ /> | <information_out_in_5> |

| | |
|---|---|
| </information_out_in_5> | <information_in name=″0200- |

| | |
|---|---|
| </exchanged_information> | 1#12-124188#1″ value=″0200-1#07- |
| ................ | 004449#1″ /> |

| | |
|---|---|
| <Resources /> | </information_out_in_5> |

| | |
|---|---|
| <Constraints /> | </exchanged_information> |

| | |
|---|---|
| </operation2> | ................ |
| <operation3> | <Resources /> |

| | |
|---|---|
| ................ | <Constraints /> |

| | |
|---|---|
| </operation3> | </operation2> |

| | |
|---|---|
| .................. | <operation3> |

| | |
|---|---|
| </Specific Part> | ................ |

</operation3>

..................

</Specific Part>

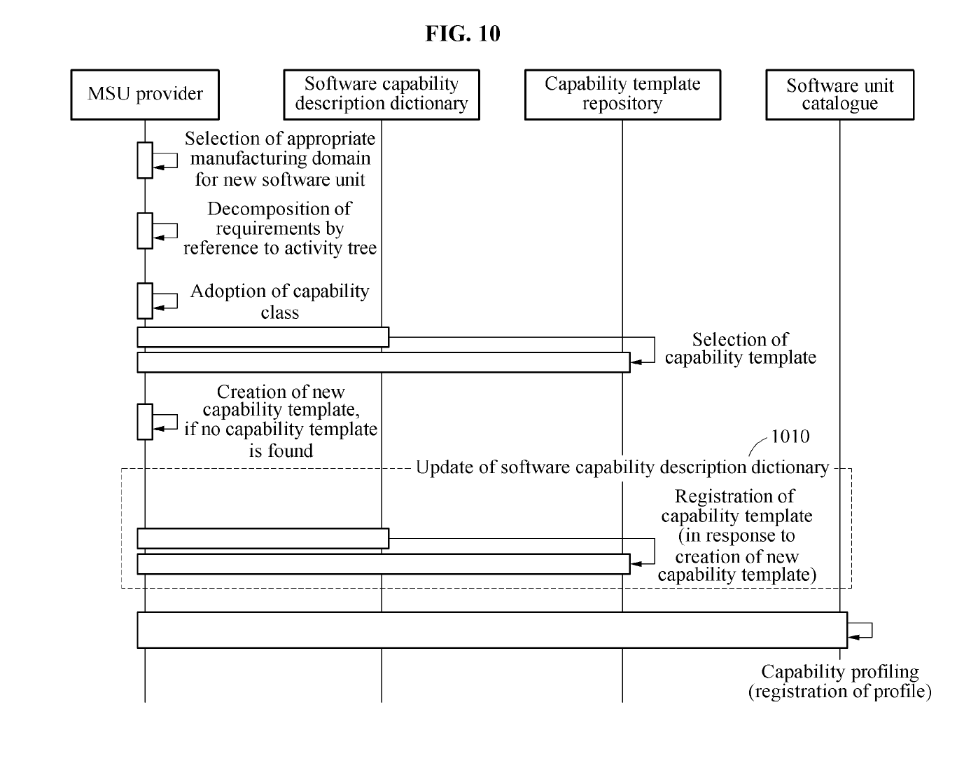

FIG. 10 is a diagram illustrating an update of a software capability description dictionary according to an example embodiment.

All capability elements described in a capability template and filled in a capability profile may be coded as items in the software capability description dictionary. Thus, the software capability description dictionary may be updated in operation 1010 in response to a new capability template being created and registered to a capability template repository as shown in FIG. 10.

A capability element in the software capability description dictionary may have a capability element name, a capability element type, a reference MDM name, and a list of functions with function names and function types.

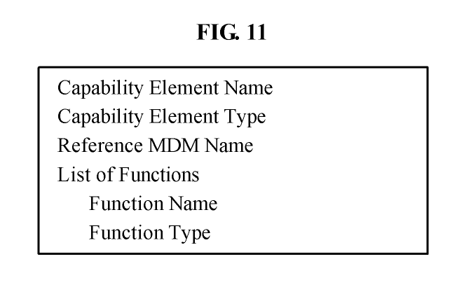

FIG. 11 is a diagram illustrating a conceptual structure of a capability element template according to an example embodiment.

A capability element template may inherit an MDD template. Thus, the capability element template may include a base part and an extension part. The base part may include the following elements:

a. Capability element name;

b. Capability element type (that may be used to distinguish a manufacturing function represented by the capability element);

c. Reference MDM name;

d. Function name—for each function in a capability element; and

e. Function type—for each function in a capability element.

The extension part of the capability element template may include other attributes to support capability element types that are associated with an industry domain, an industry organization, or an industry application. The conceptual structure of the capability element template is shown in FIG. 11.

A formal template structure of a capability element is shown below.

```
<?xml version=“1.0” encoding=“UTF-8”?>
<xs:schema.xmlns:xs=“http://www.w3.org/2001/XMLSchema”>
  <xs:element name =“Capability_Element”>
    <xs:complexType>
      <xs:sequence>
        <xs:element name=“Capability_Element_Name”>
          <xs:complexType>
            <xs:attribute name=“name” type=“xs:string”
            form=“unqualified”/>
          </xs:complexType>
        </xs:element>
        <xs:element name=“Reference_MDM_Name”>
          <xs:complexType>
            <xs:attribute name= “name”
            type=“xs:string” form=“unqualified”/>
          </xs:complexType>
        </xs:element>
        <xs:element name=“List_Of_Functions”>
          <xs:complexType>
            <xs:sequence minOccurs=“0”
            maxOccurs=“unbounded”>
              <xs:element name=“Function”>
                <xs:complexType>
                  <xs:sequence>
                    <xs:element name=“Function_Name”>
                      <xs:complexType>
                        <xs:attribute name=“name”
                        type=“xs:string”
form=“unqualified”/>
                      </xs:complexType>
                    </xs:element>
                    <xs:element name=“Function_Type”>
                      <xs:complexType>
                        <xs:attribute name=“type”
                        type=“xs:string”
form=“unqualified”/>
                      </xs:complexType>
                    </xs:element>
                  </xs:sequence>
                  <xs:attribute name=“id” type=“xs:string”
                  form=“unqualified”/>
                </xs:complexType>
              </xs:element>
            </xs:sequence>
          </xs:complexType>
        </xs:element>
      </xs:sequence>
    </xs:complexType>
  </xs:element>
</xs:schema>
```

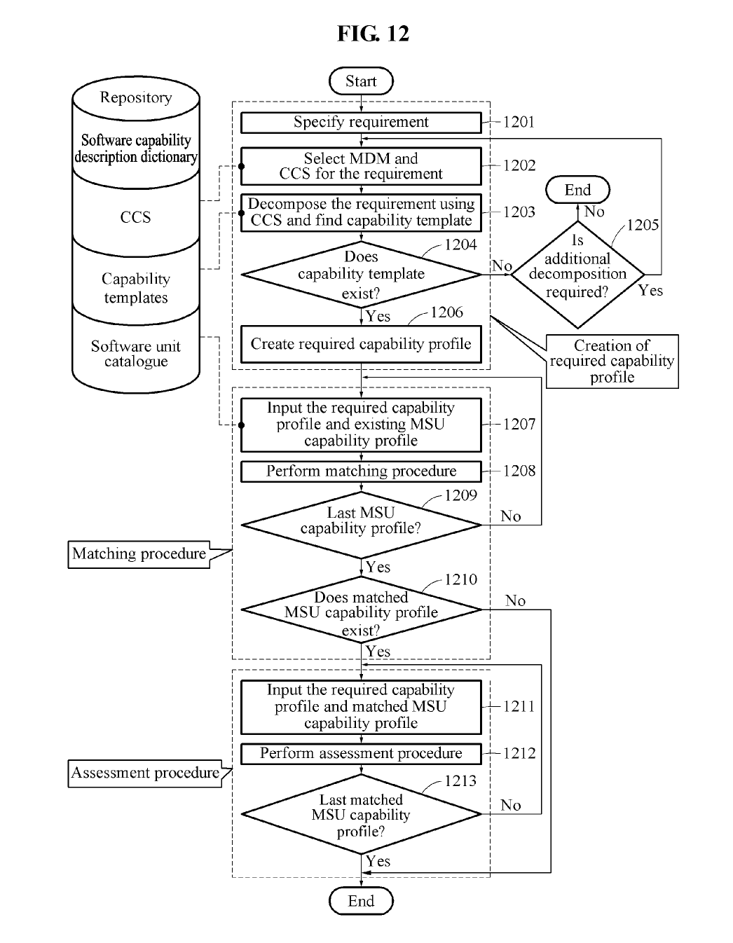

FIG. 12 is a diagram illustrating an overall procedure of a capability unit assessment according to an example embodiment.

Hereinafter, a search method to acquire a candidate capability unit that satisfies a manufacturing application requirement from a software unit catalogue. The search method may be performed using terms described in a software capability description dictionary. Also, a structure of a report may be described as a search result. A search report may indicate an extent to which a candidate from the software unit catalogue corresponds to a manufacturing application requirement.

A capability element may refer to a specific type of a MDM used to indicate that a specific capability is supported by an entity or a manufacturing software unit (MSU) to which the capability element belongs.

A capability profile may be an instance of a capability template filled with concrete values corresponding to a target MSU.

A capability profiling may be defined as a selection of a set of provided services defined by a specific interface within a software interoperability framework.

A capability template may be a schema representing a capability class.

An MSU may be a class of a software resource that includes one or more manufacturing software components and that performs a definite function or role within a manufacturing activity while supporting a common information exchange mechanism with other units. The MSU may be modeled using an UML as a software object.

A software unit catalogue may be a collection of capability profiles using the same capability template representing one or more MSUs for the same manufacturing activity in an activity tree.

A software unit catalogue repository may be a database configured to store a software unit catalogue.

A matched MSU capability profile may be one or more MSU capability profiles that perform capabilities defined in a required capability profile.

An assessment may be an evaluation of a matched MSU capability profile with respect to a cooperation with other MSU capability profiles that constitute a manufacturing application.

An assessment indicator may be a requirement to be evaluated by checking an interoperability between existing MSU capability profiles.

An assessed MSU capability profile may be one or more matched MSU capability profiles evaluated by an assessment procedure to support an interoperability between existing MSU capability profiles.

An assessment report may be a report of an assessment on the matched MSU capability profile and may be represented by an assessed MSU capability profile.

MDD may be information about manufacturing resources, manufacturing activities, or items exchanged among manufacturing resources within a specific manufacturing domain.

The software capability description dictionary may be a dictionary for capability elements to describe a capability of software.

The software capability description dictionary may be used to understand semantics of a capability profile in a software unit catalogue. The software capability description dictionary may define a capability element to describe a capability of software.

Hereinafter, a capability unit assessment for a manufacturing application requirement may be defined. An MSU user may reuse an existing software unit capability in a software unit catalogue repository for an interoperability.

For example, when a new manufacturing application is created, it may be recommended for an MSU user to use an existing MSU provided by an MSU provider.

To use the existing MSU, the MSU user may specify a manufacturing application requirement as a capability profile, and may match an existing MSU capability profile in a software unit catalogue with a required capability profile.

To match the existing MSU capability profile with the required capability profile, semantics of capability profiles may need to be understood based on the software capability description dictionary that defines capability elements to describe the capability of software.

Capability unit matching may be applied based on the following requirements. For example, a capability profile may be described according to rules defined in International Organization for Standardization (ISO) 16300-2, and may use a capability template registered in a capability template repository. Also, the capability template and the capability profile may use common terms that are defined in the software capability description dictionary.

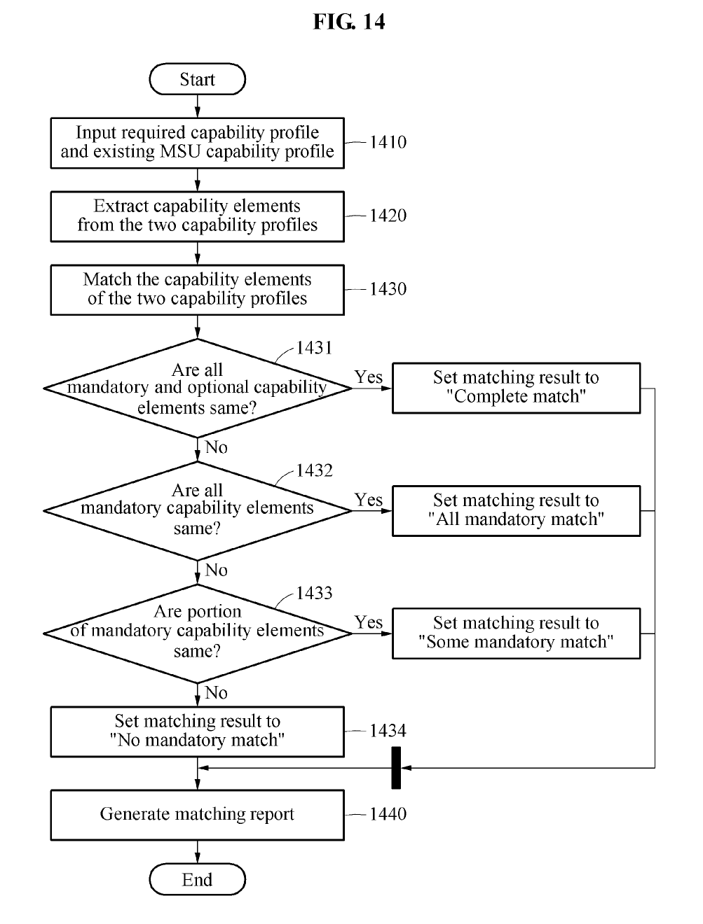

A procedure for MSU capability unit matching will be further described below with reference to FIG. 14.

A set of MSUs may be sequenced and scheduled to constitute a manufacturing application. Thus, the matched MSU capability profile may be assessed in terms of an interoperability with other MSUs that are sequenced and scheduled together.

The capability template may include one or more assessment indicators among a communication protocol, data sharing, data exchange, and service calling.

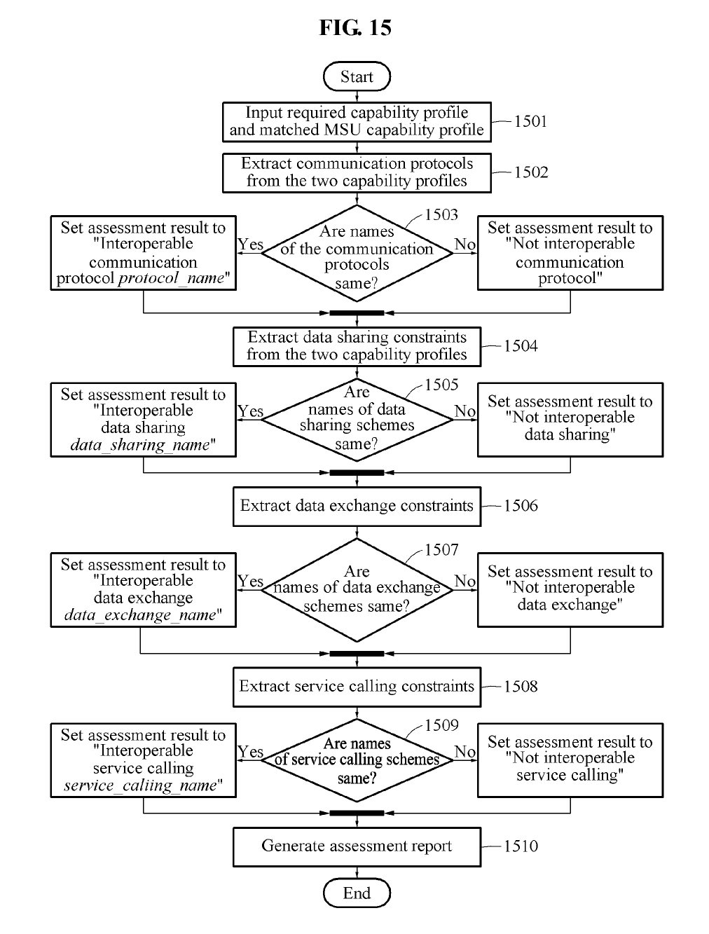

A procedure for an MSU capability unit assessment will be further described below with reference to FIG. 15.

Whether the matched MSU capability profile is interoperable with other associated MSUs may be assessed. FIG. 12 illustrates an overall procedure of a capability unit assessment. Operations 1201 to 1213 of FIG. 12 may be performed by an apparatus for managing software.

In operation 1201, a requirement for a new manufacturing application may be specified.

In operation 1202, an MDM and a CCS for the requirement may be selected.

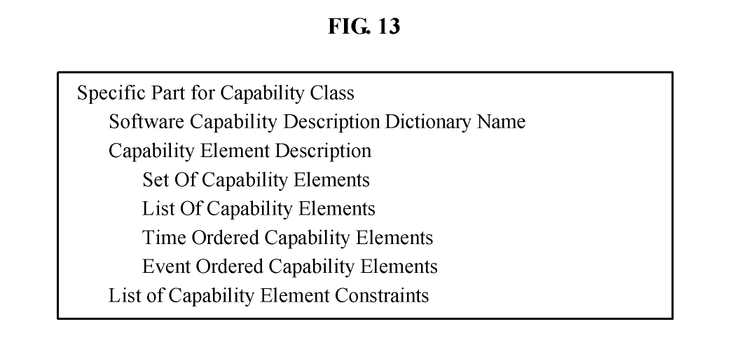

In operation 1203, a required capability may be decomposed into a single capability or a set of capabilities, and a capability template may be found, which will be further described below with reference to FIG. 13.

In operation 1204, whether a capability template for the decomposed capability exists may be determined. When the capability template for the decomposed capability exists, operation 1206 may be performed. When the capability template for the decomposed capability does not exist, operation 1205 may be performed.

In operation 1205, whether an additional decomposition is required may be determined. When the additional decomposition is required, operation 1202 may be reperformed. When the additional decomposition is not required, the procedure may be stopped.

In operation 1206, the decomposed capability may be described as a required capability profile, to generate the required capability profile, which will be further described below with reference to FIG. 13. In operation 1207, the required capability profile and an existing MSU capability profile may be input to a matching procedure.

In operation 1208, the matching procedure may be performed. The matching procedure will be further described below with reference to FIG. 14.

In operation 1209, whether a matching target is a last MSU capability profile may be determined. When a matching procedure for the last MSU capability profile is completed, operation 1210 may be performed. When the matching procedure is not completed, operation 1207 may be reperformed.

In operation 1210, whether a matched MSU capability profile exists may be determined. When at least one matched MSU capability profile exists, operation 1211 may be performed. When at least one matched MSU capability profile does not exist, the procedure may be stopped.

In operation 1211, the required capability profile and the matched MSU capability profile may be input to an assessment procedure.

In operation 1212, the assessment procedure may be performed. The assessment procedure will be further described below with reference to FIG. 15.

In operation 1213, whether an assessment target is a last matched MSU capability profile may be determined. When an assessment procedure for the last matched MSU capability profile is finished, the procedure may be stopped. When the assessment procedure for the last matched MSU capability profile is not finished, operation 1211 may be reperformed.

FIG. 13 is a diagram illustrating a conceptual structure of a specific part in a capability template according to an example embodiment.

A CCS may be used to represent a structure of capability classes for a decomposition of required capabilities. When a CCS for a manufacturing application to be developed exists in a CCS repository, the CCS may be used. When the CCS does not exist in the CCS repository, a new CCS may be created and registered to the CCS repository.

Each decomposed capability may be profiled as a required capability profile. Required capability profiles may be matched with existing MSU capability profiles in a software unit catalogue. For example, when a matched MSU capability profile does not exist, a decomposition may be performed again to create different capability profiles for successful matching.

Decomposed capabilities may be profiled as required capability profiles using capability templates. When a capability template exists, the capability template may be filled with concrete values to create a required capability profile. When the capability template does not exist, a new capability template may be created and registered to the capability template repository.

In the present disclosure, an assessment indicator represented as a capability element constraint may be defined. The assessment indicator may be compared to constraints of capability elements of matched MSU capability profiles. The assessment indicator may include an element that at least satisfies assessment requirements defined in FIG. 15.

FIG. 13 illustrates a conceptual structure of a specific part in a capability template for a required capability profile according to an example embodiment.

FIG. 14 is a flowchart illustrating a capability unit matching procedure according to an example embodiment.

In the capability unit matching procedure of FIG. 14, capability elements specified in a required capability profile may be compared to capability elements of an existing MSU capability profile. A capability unit matching may be based on a type 1 matcher for a capability template derived from the same capability class and a type 2 matcher for a capability template derived from different capability classes.

FIG. 14 illustrates a capability unit matching procedure performed by an apparatus for managing software according to an example embodiment. A matching process may be started with two capability profiles for a given activity.

In operation 1410, two capability profiles, that is, a required capability profile and an existing MSU capability profile may be input to a matching procedure.

In operation 1420, capability elements may be extracted from the two capability profiles.

In operation 1430, capability elements of the existing MSU capability profile may be matched with capability elements of the required capability profile. A capability profile may be a set of mandatory capability elements and optional capability elements.

In operation 1431, whether all mandatory capability elements and optional capability elements are the same may be determined. In an example, when all the mandatory capability elements and optional capability elements are the same, a matching result may be set to “Complete match” and operation 1440 may be performed. In another example, when all the mandatory capability elements and optional capability elements are not the same, operation 1432 may be performed.

In operation 1432, whether all the mandatory capability elements are the same may be determined. When all the mandatory capability elements are the same, the matching result may be set to “All mandatory match” and operation 1440 may be performed. When all the mandatory capability elements are not the same, operation 1433 may be performed.

In operation 1433, whether the mandatory capability elements are partly the same may be determined. When the mandatory capability elements are partly the same, the matching result may be set to “Some mandatory match” and operation 1440 may be performed. When the mandatory capability elements are partly different, operation 1434 may be performed.

When any mandatory capability elements are not the same, the matching result may be set to “No mandatory match” in operation 1434. Operation 1440 may be performed.

In operation 1440, the matching result may be reported and a matching report may be generated. After the matching procedure, matched MSU capability profiles may be assessed.

The matching procedure may be performed for existing MSU capability profiles using the same capability template.

FIG. 15 is a flowchart illustrating an assessment procedure according to an example embodiment.

Matched MSU capability profiles according to an example embodiment may be assessed in terms of an interoperability with other MSUs. A capability profile may have one or more assessment indicators to assess an interoperability. An assessment indicator may include, for example, a communication protocol (for example, Open Platform Communication Unified Architecture (OPC-UA)), data sharing (for example, Data Base Management System (DBMS)), data exchange (for example, MTConnect), and service calling (for example, Representational state transfer (REST)).

FIG. 15 illustrates an assessment procedure performed by an apparatus for managing software according to an example embodiment. The assessment procedure may be started with two capability profiles, that is, a required capability profile and a matched MSU capability profile.

In operation 1501, the required capability profile and the matched MSU capability profile may be input to the assessment procedure.

In operation 1502, communication protocols may be extracted from the two capability profiles.

In operation 1503, whether names of the communication protocols are the same may be determined. When the names of the communication protocols are the same, an assessment result may be set to “Interoperable communication protocol protocol name” and operation 1504 may be performed. When the names of the communication protocols are not the same, the assessment result may be set to “Not interoperable communication protocol” and operation 1504 may be performed.

In operation 1504, data sharing constraints may be extracted from the two capability profiles.

In operation 1505, whether names of data sharing schemes are the same may be determined. When the names of the data sharing schemes are the same, the assessment result may be set to “Interoperable data sharing data sharing name” and operation 1506 may be performed. When the names of the data sharing schemes are not the same, the assessment result may be set to “Not interoperable data sharing” and operation 1506 may be performed.

In operation 1506, data exchange constraints may be extracted.

In operation 1507, whether names of data exchange schemes are the same may be determined. When the names of the data exchange schemes are the same, the assessment result may be set to “Interoperable data exchange data_exchange_name” and operation 1508 may be performed. When the names of the data exchange schemes are not the same, the assessment result may be set to “Not interoperable data exchange” and operation 1508 may be performed.

In operation 1508, service calling constraints may be extracted.

In operation 1509, whether names of service calling schemes are the same may be determined. When the names of the service calling schemes are the same, the assessment result may be set to “Interoperable service calling service calling name” and operation 1510 may be performed. When the names of the service calling schemes are not the same, the assessment result may be set to “Not interoperable service calling” and operation 1510 may be performed.

In operation 1510, the assessment result may be reported and an assessment report may be generated. Matched MSU capability profiles may be represented as assessed MSU capability profiles in the assessment report.

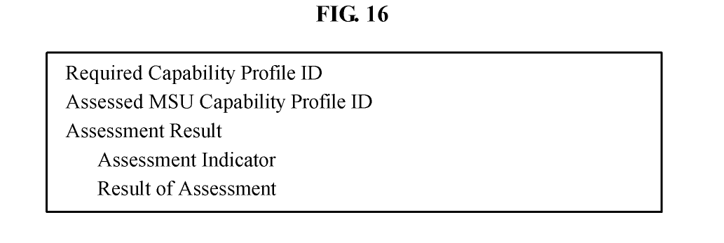

FIG. 16 is a diagram illustrating a conceptual structure of an assessment report according to an example embodiment.

Contents of the assessment report may include an identification (ID) of a required capability profile, an ID of an assessed MSU capability profile, and an assessment result for each assessment indicator. FIG. 16 illustrates the conceptual structure of the assessment report.

For example, a formal structure of an assessment report may be shown below.

```
<?xml version=“1.0” encoding=“utf-8”?>
<xs:schema xmlns:xs=“http://www.w3.org/2001/XMLSchema”
elementFormDefault=“qualified” attributeFormDefault=“unqualified”>
    <xs:element name=“AssessmentReport”>
          <xs:complexType>
      <xs:sequence>
        <xs:element name=“RequiredCapabilityProfileID”
        type=“xs:string” />
        <xs:element name=“MatchedMsuProfileID”
        type=“xs:string” />
        <xs:element name=“AssessmentResult”>
          <xs:complexType>
            <xs:sequence>
              <xs:element name=“CommunicationProtocol” >
                <xs:complexType>
                  <xs: sequence>
                    <xs:element name=
                    “CommunicationProtocolName”
                  minOccurs=“0” maxOccurs=“unbounded”>
                      <xs:complexType>
                        <xs:attribute name=“usage”
                        type=“xs:string”
                      use=“optional”/>
                        <xs:attribute name=“name”
                        type=“xs:string”
                      use=“optional”/>
                      </xs:complexType>
                    </xs:element>
                  </xs: sequence>
                  <xs:attribute name=“result”
                  type=“AssessmentResult”
            use=“required”/>
            </xs:complexType>
          </xs:element>
        <xs:element name=“DataSharing”>
        <xs:complexType>
          <xs:sequence>
            <xs:element name=“DataSharingName”
            minOccurs=“0”
            maxOccurs=“unbounded”>
              <xs:complexType>
                <xs:attribute name=“usage”
                type=“xs:string” use=“optional”/>
                <xs:attribute name=“name”
                type=“xs:string” use=“optional”/>
              </xs:complexType>
            </xs:element>
          </xs:sequence>
          <xs:attribute name=“result” type=“AssessmentResult”
          use=“required”/>
        </xs:complexType>
        </xs:element>
        <xs:element name=“DataExchange”>
        <xs:complexType>
          <xs:sequence>
            <xs:element name=“DataExchangeName”
            minOccurs=“0”
            maxOccurs=“unbounded”>
              <xs:complexType>
                  <xs:attribute name=“usage”
                  type=“xs:string” use=“optional”/>
                  <xs:attribute name=“name”
                  type=“xs:string” use=“optional”/>
                </xs:complexType>
            </xs:element>
          </xs:sequence>
        <xs:attribute name=“result”
        type=“AssessmentResult” use=“required”/>
        </xs:complexType>
      </xs:element>
    <xs:element name=“ServiceCalling”>
      <xs:complexType>
        <xs:sequence>
          <xs:element name=“ServiceCallingName”
          minOccurs=“0”
          maxOccurs=“unbounded”>
            <xs:complexType>
              <xs:attribute name=“usage”
              type=“xs:string” use=“optional”/>
              <xs:attribute name=“name”
              type=“xs:string” use=“optional”/>
            </xs:complexType>
          </xs:element>
        </xs:sequence>
      <xs:attribute name=“result” type=“AssessmentResult”
      use=“required”/>
        </xs:complexType>
      </xs:element>
      </xs: sequence>
      </xs:complexType>
      </xs:element>
      <xs:element name=“AssessmentComment”
      type=“xs:string” minOccurs=“0” />
    </xs:sequence>
  </xs:complexType>
  </xs:element>
  <xs:simpleType name=“AssessmentResult”>
    <xs:restriction base=“xs:string”>
      <xs:enumeration value=“Interoperable” />
      <xs:enumeration yalue=“Not Interoperable” />
  </xs:restriction>
</xs:simpleType>
</xs: schema>
```

An MSU provider and an MSU user may utilize capability templates by extensible markup language (XML) schemas. An example of a capability template may be shown below.

An MSU user may create a required capability profile using a capability template by XML schemas. An example of the required capability profile may be shown below.

```
<?xml version=“1.0” encoding=“UTF-8”?>
<CapabilityProfiling>
    <Type id=“ReqProf_786z7” />
    <CapabilityProfile date=“2018-02-12”>
    <Pkgtype version=“V01.01.01” />
    <Common>
    <Requirement>
      <ID>SYS-REQ2018-0001</ID>
    </Requirement>
    <ReferenceCapabilityClassStructure id=“rcs_1001”
    name=“DiscreteManufacturingActivity” version=“0001” url=“” />
    <TemplateID id=“manuAct32” />
    <Capability_Class_Name name=“B11_ReceiveOrder_Activity” />
    <Reference_Capability_Class_Structure_Name name=
    “REQ Structure” />
    <Version major=“7” minor=“3” />
    <Owner>
      <Name>MM Production Inc.</Name>
      <Street> Summer Ave.7</Street>
      <City>Softcity</City>
      <Zip>4711</Zip>
      <State>CA</State>
      <Country>USA</Country>
      <Comment>Only best experiences!</Comment>
    </Owner>
    <ComputingFacilities type=“required”>
      <Processor type=“INTEL” />
      <OperatingSystem type=“LINUX” />
      <Language name=“EN” />
      <Memory size=“28” unit=“MB” />
      <DiskSpace size=“30” unit=“GB” />
    </ComputingFacilities>
    <Performance elapsedTime=“61ms”
    transactionsPerUnitTime=“621” />
    <ReliabilityData>
      <UsageHistory>
        abc1
        abc2
      </UsageHistory>
      <Shipments number=“55” />
      <IntendedSafetyIntegritylevel=“3” />
      <Certification number=“ISO9001” />
  </ReliabilityData>
  <SupportPolicy index=“23” />
  <PriceData invest=“12000” annualSupport=“2400” unit=“USD” />
  <ReferenceDictionaryName name=
  “SoftwareCapabilityDescriptionDictionary” />
  <NumberOfProfileAttributes number=“50” />
  <NumberOfMethods number=“10” />
  <NumberOfResources number=“100” />
  <NumberOfConstraints number=“5” />
  <NumberOfExtensions number=“5” />
  <NumberOfLowerLevels number=“3” />
  <NumberOfSubtemplatesAtNextLowerLevel number=“3” />
</Common>
  <Specific>
    <AssessmentIndicatorDescriptionFormat name=“format1001” />
    <ListOfCapabilityElementConstraints>
      <CommunicationProtocol>
        <CommunicationProtocolName usage=“ToPC” name=“TCP”/>
        <CommunicationProtocolName usage=“ToController”
        name=“OPC-UA” />
      </CommunicationProtocol>
      <DataSharing>
        <DataSharingScheme name=“SQL” />
      </DataSharing>
      <DataExchange>
      </DataExchange>
      <ServiceCalling>
        <ServiceCallingScheme name=“REST” />
      </ServiceCalling>
    </ListOfCapabilityElementConstraints>
  </Specific>
</CapabilityProfile>
</CapabilityProfiling>
```

An assessment report may be generated as a result of an assessment. An example of the assessment report may be shown below.

```
<?xml version=“1.0” encoding=“utf-8”?>
<AssessmentReport>
  <RequiredCapabilityProfileID>REQ17-0001
  </RequiredCapabilityProfileID>
  <MatchedMsuProfileID>MSU17-0001
  </MatchedMsuProfileID>
  <AssessmentResult>
    <CommunicationProtocol result=“Interoperable”>
      <CommunicationProtocolName usage=“ToPC”
      name=“TCP” />
      <CommunicationProtocolName usage=“ToController”
      name=“OPC-UA” />
    </CommunicationProtocol>
    <DataSharing result=“Not Interoperable” />
    <DataExchange result=“Not Interoperable” />
    <ServiceCalling result=“Interoperable”>
    <ServiceCallingName name=“REST” />
    </ServiceCalling>
  </AssessmentResult>
  <AssessmentComment>Any comments
  </AssessmentComment>
</AssessmentReport>
```

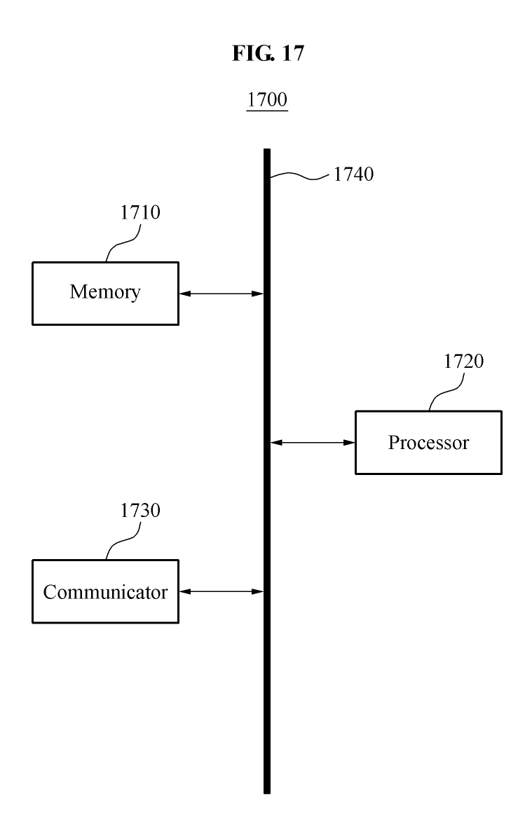

FIG. 17 is a diagram illustrating an apparatus 1700 for managing software according to an example embodiment.

Referring to FIG. 17, the apparatus 1700 includes a memory 1710, a processor 1720 and a communicator 1730. The memory 1710, the processor 1720 and the communicator 1730 may communicate with each other via a bus 1740.

The memory 1710 may store an instruction readable in a computer. The processor 1720 may perform the above-described operations in response to the instruction stored in the memory 1710 being executed by the processor 1720. The memory 1710 may include, for example, a volatile memory or a nonvolatile memory.

The processor 1720 may be an apparatus configured to execute instructions or programs, or to control the apparatus 1700. The apparatus 1700 may be connected to an external device (for example, an MSU provider or an MSU user) via the communicator 1730 and may exchange data.

The processor 1720 may decompose a requirement input by a user into one or more capabilities using a CCS corresponding to the requirement, may create a required capability profile corresponding to the requirement using a capability template corresponding to the decomposed capabilities, may match the required capability profile and an existing capability profile in a software unit catalogue, and may assess the existing capability profile matched with the required capability profile.

Also, the processor 1720 may decompose requirements for a new software unit into a plurality of primitive requirements by reference to an activity tree in domain activities, may select a capability template corresponding to a capability class that satisfies the decomposed requirements, may create a capability profile by filling the capability template with concrete values of the new software unit, and may register the capability profile to a software unit catalogue.

The apparatus 1700 may also process the above-described operations.

According to example embodiments, it is possible to assess a software interoperation level between a capability requirement of a consumer and a capability description of a provider providing software for a smart factory.

According to example embodiments, it is possible to recommend software for an optimal smart factory corresponding to a capability requirement to a consumer.

According to example embodiments, it is possible to prevent redundant software for a similar smart factory from being developed by a provider and possible to efficiently manage resources of software for a smart factory.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The modules, apparatuses, and other components described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for to purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of managing software, the method comprising:
decomposing a requirement input by a user into one or more capabilities using a capability class structure (CCS) corresponding to the requirement;
creating a required capability profile corresponding to the requirement using a capability template corresponding to the capabilities;
matching the required capability profile and an existing capability profile in a software unit catalogue; and
assessing the existing capability profile matched with the required capability profile.

2. The method of claim 1, further comprising:
determining whether a CCS for a manufacturing application to be developed exists in a CCS repository; and
creating a CCS for a decomposition of the requirement into one or more capabilities and registering the created CCS to the CCS repository when the CCS does not exist in the CCS repository.

3. The method of claim 2, wherein the CCS represents a structure of capability classes for a decomposition of required capabilities.

4. The method of claim 1, wherein the decomposing of the requirement comprises decomposing the requirement into one or more capabilities again when an existing capability profile matched with the required capability profile does not exist.

5. The method of claim 1, wherein when the capability template corresponding to the capabilities does not exist, a capability template corresponding to the capabilities is created and registered to a capability template repository.

6. The method of claim 1, wherein the matching of the required capability profile and the existing capability profile comprises comparing capability elements specified in the required capability profile to capability elements of the existing capability profile, and matching the required capability profile and the existing capability profile.

7. The method of claim 6, wherein the matching of the required capability profile and the existing capability profile comprises matching the required capability profile and the existing capability profile based on whether a mandatory capability element and an optional capability element of the required capability profile are the same as a mandatory capability element and an optional capability element of the existing capability profile, respectively.

8. The method of claim 1, wherein the assessing of the existing capability profile comprises assessing an interoperability between existing capability profiles matched with the required capability profile.

9. The method of claim 1, wherein the assessing of the existing capability profile comprises assessing the existing capability profile based on an assessment indicator that includes at least one of a communication protocol, data sharing, data exchange, and service calling.

10. The method of claim 1, further comprising:
outputting a result of the assessing as an assessment report.

11. The method of claim 10, wherein the assessment report comprises an identification (ID) of the required capability profile, an ID of the assessed existing capability profile, and an assessment result for each assessment indicator.

12. The method of claim 1, wherein the capability template, the required capability profile and the existing capability profile are based on common terms defined in a software capability description dictionary.

13. A method of managing software, the method comprising:
decomposing requirements for a new software unit into a plurality of primitive requirements by reference to an activity tree in domain activities;
selecting a capability template corresponding to a capability class that satisfies the decomposed requirements;
creating a capability profile by filling the capability template with concrete values of the new software unit; and
registering the capability profile to a software unit catalogue.

14. The method of claim 13, wherein the selecting of the capability template comprises:
determining whether the capability template corresponding to the capability class exists in a capability template repository by reference to a software capability description dictionary;
creating a new capability template with the same formal structure as a formal structure of the capability template when the capability template does not exist in the capability template repository; and
registering the created new capability template to the capability template repository, and
wherein the software capability description dictionary is updated to reflect semantics of the created new capability template.

15. The method of claim 14, wherein a capability element in the software capability description dictionary comprises a capability element name, a capability element type, a name of a reference manufacturing domain model (MDM), and a list of functions with function names and function types.

16. The method of claim 13, wherein the creating of the capability profile comprises creating the capability profile by coding capability elements to recognize semantics.

17. The method of claim 13, further comprising:
selecting a manufacturing domain for the new software unit.

18. The method of claim 13, wherein a capability class that satisfies the decomposed requirements is created or is reused when an existing capability class satisfies the decomposed requirements.

19. An apparatus for managing software, the apparatus comprising:
a processor; and
a memory comprising at least one instruction that is executable by the processor,
wherein when the at least one instruction is executed by the processor, the processor is configured to decompose a requirement input by a user into one or more capabilities using a capability class structure (CCS) corresponding to the requirement, configured to create a required capability profile corresponding to the requirement using a capability template corresponding to the decomposed capabilities, configured to match the required capability profile and an existing capability profile in a software unit catalogue, and configured to assess the existing capability profile matched with the required capability profile.
